(19) United States
(12) Patent Application Publication
(10) Pub. No.: US 2014/0019160 A1
(43) Pub. Date: Jan. 16, 2014

(54) Verifying Charge Codes

(71) Applicants: Francisco Loya, III, Harlingen, TX (US); Michael Williams, Fredericksburg, TX (US)

(72) Inventors: Francisco Loya, III, Harlingen, TX (US); Michael Williams, Fredericksburg, TX (US)

(73) Assignee: CMO RX Inc.

(21) Appl. No.: 13/550,035

(22) Filed: Jul. 16, 2012

(51) Int. Cl. G06Q 50/24

(52) U.S. Cl. 705/3

(57) ABSTRACT

Systems, methods, and computer program products involve receiving, electronically, medical information about a patient of a medical provider from an electronic medical record. A charge code associated with a medical condition of the patient can be automatically identified from a specified set of a plurality of charge codes upon which a third party will base payment to the medical provider using the received medical information. The charge code can be outputted.

### FIELD

The present disclosure is directed to verifying charge codes, and more particularly, to identifying charge codes and providing recommended charge codes.

### BACKGROUND

Charge codes are used by health care providers and health care professionals to uniquely identify medical conditions and/or procedures. A charge code can be uniquely associated with a medical condition or procedure. For example, an atrial fibrillation may have the code 427.31 associated with it. The American Medical Association maintains the Current Procedural Terminology (CPT) code set. The CPT is identified by the Centers for Medicare and Medicaid Services (CMS). In addition to the CPT code set, the World Health Organization (WHO) maintains and promulgates the International Statistical Classification of Diseases and Related Health Problems (briefly, ICD). ICD is a medical classification that provides codes to classify diseases and a wide variety of signs, symptoms, abnormal findings, complaints, social circumstances, and external causes of injury or disease. ICD-9 and ICD-10 are examples of code set revisions used in the United States and elsewhere. Codes can be used for billing purposes, as well as for other purposes.

### SUMMARY

The present disclosure is directed to identifying charge codes based on medical information received from a medical professional or healthcare provider. A diagnosis, medical condition, treatment, lab, procedure, or other medical information for a patient can be received from a medical professional, such as a physician (or a physician's office) or other medical professional. Other medical information can also be received, such as the patient's medical history, current labs, prescriptions, etc. To the extent that the received medical information has not identified a charge code, the medical information can be associated with a charge code. In certain implementations, one or more charge codes can be identified based on the received medical information. For example, in some instances diagnosing and treating a first illness may cure or treat a second illness or condition. The charge codes for the diagnosis of the first illness and the second illness or condition may both be paid for by a third party payor, because both were treated, but the attending physician may not make a separate diagnosis for the second illness or condition. Therefore, the second illness or condition and it's corresponding charge codes can be identified based on a report from the physician that includes a diagnosis and/or other medical information. In some circumstances, a physician's understanding of a condition does not exactly line up with how charge codes are defined. The charge codes can be sent back to the medical professional for verification. The medical professional can then approve or disapprove of the charge codes. The medical professional can also add new charge codes or medical information. The identification, recommendation, and verification of charge codes facilitates a more comprehensive diagnosis and treatment plan. Medical professionals and facilities can receive the proper amount of funding/payment. In addition, comparative studies can be performed and metrics collected based on, for example, the identification of charge codes to be recommended and the verification of recommended charge codes received. Providing comprehensive charge codes to insurance carriers, including Medicare and Medicaid, can also affect risk adjusted mortality for medical facilities. For example, for Medicare and Medicaid, a certain percentage of payout is withheld and periodically redistributed based on the medical facilities risk adjusted mortality score. Those with higher than average scores get the withheld amount plus an additional percentage. Those with lower scores may get less than the withheld amount or nothing at all. Comprehensive charge coding ensures that the medical facility comprehensively reports diagnoses so that it can receive the appropriate risk adjusted mortality score.

Aspects of the disclosure involve systems, computer-implemented methods, and/or computer program products tangibly stored on non-transient computer readable storage media. Medical information about a patient of a medical provider can be electronically received from an electronic medical record. A charge code associated with a medical condition of the patient can be automatically identified from a specified set of a plurality of charge codes upon which a third party will base payment to the medical provider using the received medical information. The charge code can be output to a destination device, server, repository, or other location, either electronically or physically.

In certain aspects of the embodiments, receiving the medical information may include receiving a diagnosis of the medical condition and the examination information, test information, lab information, imaging information, and pharmaceutical information associated with the diagnosis.

In certain aspects of the embodiments, the diagnosis and any associated examination information, test information, lab information and pharmaceutical information is from a specified timeframe. Receiving the medical information may include receiving at least one of a historical diagnosis of another medical condition, historical examination information, historical test information, historical lab information, historical imaging information, or historical pharmaceutical information from a timeframe before the specified timeframe.

In certain aspects of the embodiments, the charge code may be a first charge code corresponding to the medical condition, and the method further comprises automatically identifying a second charge code corresponding to a second medical condition for which no diagnosis is identified in the medical information. Automatically identifying the second charge code may include automatically identifying the second charge code using the first charge code.

In certain aspects of the embodiments, outputting the charge code may include outputting the charge code to a physician and prompting a confirmation from the physician that the charge code is correct.

Certain aspects of the embodiments may also include identifying a second charge code associated with the procedure and providing the second charge code to the physician.

Certain aspects of the embodiments may include transmitting the charge code to the third party payor.

The details of one or more embodiments are set forth in the accompanying drawings and the description below. Other features, objects, and advantages of the invention will be apparent from the description and drawings, and from the claims.

### DESCRIPTION OF THE DRAWINGS

FIG. 1 is a schematic block diagram of an example system for identifying and verifying charge codes.

FIGS. 2A-2B are screen shots of an example graphical user interface for showing a diagnostic report for a patient.

FIG. 3(A) is a screenshot of an example graphical user interface showing information pertaining to a medical condition.

FIG. 3(B) is a screenshot of an example graphical user interface showing a definition pertaining to a medical condition.

FIG. 3(C) is a screenshot of an example graphical user interface showing further information pertaining to a medical condition.

FIG. 4(A) is a screenshot of an example graphical user interface showing historical pharmacy data for a patient.

FIG. 4(B) is a screenshot of an example graphical user interface showing historical laboratory data for a patient.

FIG. 5 is a screenshot of an example graphical user interface showing the frequency of certain diagnostic related groups.

FIG. 6 is a screenshot of an example graphical user interface showing an example twelve month utilization for a certain diagnostic related group.

FIG. 7 is a screenshot of an example graphical user interface showing an example pharmacy utilization report for a certain physician compared against other physicians of the same medical facility.

FIG. 8 is a screenshot of an example graphical user interface showing example in-patient notes.

FIG. 9 is a process flow diagram for identifying and verifying charge codes.

FIG. 10 is an screenshot of an example graphical user interface for a radiology utilization by physician interface.

FIG. 11 is a screenshot of an example physician query form.

### DETAILED DESCRIPTION

The present disclosure pertains to identifying charge codes. For example, when a patient visits a physician's office, the patient may present complaints indicating how the patient feels and the purpose of the visit. The physician or another medical professional can add the patients' complaints to a report, often called a chart, together with objective information, such as the patient's vital information, the results of physical examinations, imaging, and any tests or lab results for the patient. The physician may make a diagnosis of a condition based on the complaints and objective information, and possibly also the patient's medical history. The diagnosis is recorded on the chart, as well as the physician's plan for treatment including any procedures and pharmaceuticals. The report may be sent to another health care professional, such as a billing professional operating a computer terminal. That professional can electronically receive and/or input information into a computer system that automatically correlates the medical information provided in the patient's report to one or more charge codes upon which a third party, such as an medical insurer or governmental agency, will base payment to the medical provider. In certain instances, the patient's medical history can also be used to identify or derive charge codes. Generally, the present disclosure pertains to comprehensively identifying charge codes from a patient's report.

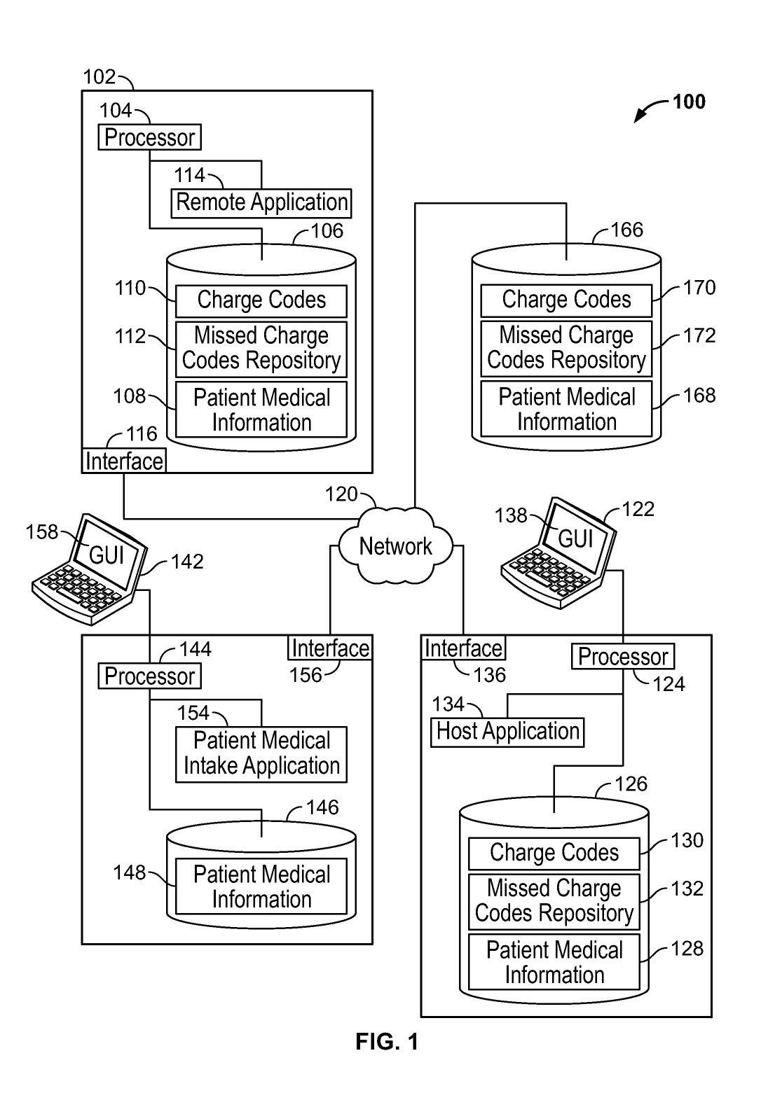

FIG. 1 is a schematic block a diagram of an example system 100 for identifying and verifying charge codes. System 100 includes a server 102, a coding terminal 122, a medical provider terminal 142, and a network 120. In certain instances, the system 100 can also include a distributed memory 166. The server 102, coding terminal 122, medical provider terminal 142, and distributed memory 166 may communicate across a network 120.

Network 120 facilitates wireless or wireline communication between computer server 102 and any other local or remote computer. Network 120 may be all or a portion of an enterprise or secured network. In another example, network 120 may be a VPN merely between server 102 and terminals, such as coding terminal 122, across a wireline or wireless link. Such an example wireless link may be via 802.11a, 802.11b, 802.11g, 802.11n, 802.20, WiMax, and many others. The wireless link may also be via cellular technologies such as the 3rd Generation Partnership Project (3GPP) Global System for Mobile Communications (GSM), Universal Mobile Telecommunications System (UMTS), Long Term Evolution (LTE), etc. While illustrated as a single or continuous network, network 120 may be logically divided into various sub-nets or virtual networks without departing from the scope of this disclosure, so long as at least portion of network 120 may facilitate communications between senders and recipients of requests and results. In other words, network 120 encompasses any internal and/or external network, networks, sub-network, or combination thereof operable to facilitate communications between various computing components in system 100. Network 120 may communicate, for example, Internet Protocol (IP) packets, Frame Relay frames, Asynchronous Transfer Mode (ATM) cells, voice, video, data, and other suitable information between network addresses. Network 120 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 120 may be a secure network associated with the system 100 and remote terminals.

Server 102 may be any computer or processing device such as a mainframe, a blade server, general-purpose personal computer (PC), Macintosh®, workstation, UNIX-based computer, or any other suitable device. Server 102 may include a processor 104 that is configured to execute instructions and/or utilize data that may be stored on a memory 106. The memory 106 may include/communicate with cloud-based memory structures. Memory 106 may securely store medical information 108 about one or more patients in an electronic medical record (EMR). The EMR can include prior diagnoses and that the system/software application can take these prior diagnoses into account when suggesting charge codes. The medical information 108 may include electronically received reports, manually entered medical information, medical history, pharmaceuticals, x-ray images and other images, and other electronic forms of medical information. The memory 106 may also store charge codes 110, and the processor 104 can execute instructions to access charge codes 110 based on medical information for a particular patient.

Server 102 includes processor 104. Processor 104 executes instructions and manipulates data to perform the operations of server 102 such as, for example, executing remote application 114 to identify charge codes based on received or stored information. Processor 104 can be a central processing unit (CPU), a blade, an application specific integrated circuit (ASIC), a field-programmable gate array (FPGA), or other processor. Although FIG. 1 illustrates a single processor 104 in server 102, multiple processors may be used according to particular needs and reference to processor 104 is meant to include multiple processors where applicable.

Server 102 may also store a remote application 114, which can be accessible across the network 120 to other computer devices. For example, remote application 114 may be a web-based application accessible to computer devices, such as coding terminal 122, across the Internet. The remote application may provide a graphical user interface (GUI) to the coding terminal 122 through which an operator can input instructions, perform analyses, access/store data remotely, generate reports, and/or transmit information.

Server 102 may also include interface 116 for communicating with other computer systems, such as coding terminal 122 and medical provider's terminal 142, over network 120 in a client-server environment or any other type of distributed environments. In certain implementations, server 102 receives requests for data access from local or remote senders through interface 116 for storage in memory 106 and/or processing by processor 104. Generally, interface 116 comprises logic encoded in software and/or hardware in a suitable combination and operable to communicate with network 120. More specifically, interface 116 may comprise software supporting one or more communication protocols associated with communications network 120 or hardware operable to communicate physical signals.

Memory 106 may include any memory or database module and may take the form of volatile or non-volatile memory including, without limitation, magnetic media, optical media, random access memory (RAM), read-only memory (ROM), removable media, or any other suitable local or remote and/or distributed memory and retrieved across a network, such as in a cloud-based computing environment. In some instances, memory can be distributed across the network, and accessible across network 120. For example, data can be stored on memory 166, which can be a remote memory or a distributed memory, or may be a cloud-type distributed memory structure, or other memory accessible across a network. The memory 166 can store charge codes 170, patient medical information 168, and/or missed charge codes 172 in database or other repository structure. Memory 166 can be accessible by, for example, the coding terminal 122 when performing charge coding identification and analysis, and can be accessible either directly across the network 120 or when executing the remote application 114 on server 102. Other ways of storing and accessing data are also contemplated in this disclosure.

Coding terminal 122 includes a display 138, a processor 124, interface 136, and a memory 126. Processor 124 can be similar to processor 104, and interface 136 can be similar to interface 116, both described above. The display 138 can be any type of display device that displays a user interface, such as a graphical user interface (GUI) to an operator. A GUI includes a graphical user interface operable to allow the user of a terminal to interface with at least a portion of system 100 for any suitable purpose, including viewing, manipulating, editing, etc., graphic visualizations of user profile data. Generally, a GUI provides the user of a terminal with an efficient and user-friendly presentation of data provided by or communicated within system 100. A GUI may comprise a plurality of customizable frames or views having interactive fields, pull-down lists, and buttons operated by the user. In one implementation, a GUI presents information associated with queries and buttons and receives commands from the user of a terminal via one of the input devices. Moreover, it should be understood that the terms graphical user interface and GUI may be used in the singular or in the plural to describe one or more graphical user interfaces and each of the displays of a particular graphical user interface. Therefore, GUI contemplates any graphical user interface, such as a generic web browser or touch screen, which processes information in system 100 and efficiently presents the results to the user. Server 102 can accept data from coding terminal 122 via the web browser (e.g., Microsoft® Internet Explorer or Mozilla® Firefox®) and return the appropriate HTML or XML responses using network 120. For example, server 102 may receive a search request from coding terminal 122 using a web browser or application-specific graphical user interface, and then may execute the request to search for business entities that fulfill certain criteria and provide the search results to the user interface.

The operator can interact with the GUI through an input interface, which can be a keyboard, mouse, touchscreen, voice activation, combination of multiple input devices, etc. The GUI can be a user interface to a host application 134 that utilizes information stored on the memory 126 and executed as instructions by a hardware processor 124. For example, host application 134 can include a software application that can receive as an input medical information received across a network 120 and automatically identify charge codes for the medical information that appears on the report. The charge codes can be identified based on an algorithm or by a lookup table or by other ways.

In certain instances, a physician or other medical professional can meet with a patient at a medical facility. The patient can present complaints, indicating how the patient is feeling. The physician can create a subjective, objective, assessment, and plan (SOAP) report or chart that includes the symptom(s), the diagnosis, and/or procedures to treat the diagnosed conditions. In addition, the physician can include in the report current vitals information, such as blood pressure, pulse, etc. The report can be sent electronically to a billing professional, such as one operating coding terminal 122, or can be provided in hard-copy and manually entered or scanned into electronic form. In certain implementations, the physician or other medical professional can operate a medical provider terminal 142, which is described in more detail below. The report can be received by the coding terminal 122. Memory 126 can be similar to memory 106 described above, and can store similar data, such as patient medical information 128 (e.g., received from medical provider terminal 142), charge codes 130, and missed charge codes repository 132.

The host application 134 running on the coding terminal 122 can automatically identify charge codes, such as CPT or IDC codes, for billing purposes. In some circumstances, however, the charge codes identified for the medical information on the report may not be comprehensive. For example, an initial set of charge codes may be identified from the explicit medical information (e.g., diagnosis, tests/labs, pharmaceuticals, and treatments from the physician's report) received from the physician. For clarity, the diagnosis initially appearing on the physician's report can be referred to as an initial diagnosis. The reported initial diagnosis may be incomplete because the physician did not identify diagnoses related to the initial diagnosis. Such an absence may occur for any number of reasons. For example, the physician's practice may be to consider a diagnosis when labs indicate a result of a certain value; but insurance companies may consider a diagnosis when labs indicate a result of a different value. Therefore, additional charge codes may apply. The host application 134 can identify other charge codes that may also apply to the treatment of the patient, including related charge codes, related to the primary diagnosis, as well as related diagnosis charge codes (i.e., charge codes for diagnoses related to the primary diagnosis). For example, based on a diagnosis or other medical information received from medical provider terminal 142, the host application can automatically identify other charge codes that may also apply. The host application can use data stored on memory 126 to do so, including the charge codes 130 and the patient medical information 128. In some implementations, patient medical information 128 can be continuously updated so it maintains up-to-date patient medical information. For example, the patient medical information 128 can be updated by the EMR database or by an automated system upon receiving patient medical information from a report or chart.

A report that includes a comprehensive set of charge codes can be retransmitted to the physician for verification. In some circumstances, the identification and transmittal of charge codes can be done in “real-time.” For example, because the system may be automated, the computer program can make suggestions for charge codes very quickly—such as in a matter of seconds or less. Contrast this speed with a manual charge coding, which can take hours per chart. Therefore, charge codes are identified (and possibly verified and transmitted to the third party payor) much faster. Additionally, fewer people are needed to process charts and/or more charts can be processed in a day. Along with electronic entry of patient medical information, automatic identification can result in real-time chart coding. The term “real-time” can reflect that results may be displayed without intentional delay, taking into account the processing limitations of the system and the time required to accurately retrieve the data.

Similarly, the physician's report may be inputted into the system in real-time. It may be advantageous, in this context, to provide the report and additional charge codes to the physician before the patient has left the visitation because the physician may want to discuss the patient's medical history, apply further procedures, etc. before the patient leaves. In addition, it is advantageous to provide the results to the physician quickly while that patient is still fresh in the physician's mind. The report can prompt the physician to accept or reject the additional charge codes (and/or corresponding medical conditions or procedures), thereby verifying the charge codes. The physician can send the verification to the coding terminal directly and electronically or to the billing professional who will then enter the verifications into the coding terminal. The coding terminal can then transmit the verified charge codes to a billing system and/or directly to the third party payor, such as a medical insurance carrier or governmental agency. The charge codes can then be used by the third party payor to determine payment to the medical provider for care of the patient.

As mentioned above, after charge codes are identified, the physician may be prompted to verify them. The system may prompt the physician of a pending verification request in real-time. That is, the request may be sent before the patient leaves the physician's office or hospital. The system may send the physician an e-mail or other electronic message or signal indicating a pending verification request. Other prompting techniques are also contemplated, including instant messaging, text messaging, BlackBerry Messaging (BBM)™, icon or other pictographic indicator, or other message or signal. The physician may receive the message, signal, or other indicator on a dedicated device, or on an application running on a smartphone, tablet, or other electronic communications device. The message itself may take on different forms. For example, the physician may receive an interactive form, a list of pending requests, a set of links, a simple message telling the physician to log into an account to access verification requests, etc. Furthermore, a dedicated system may be used that alerts the physician of charts needing the codes verified and/or lists the charts needing verification in a “first-in-first-out” arrangement, so the physician can see how long her list is and can address the oldest requests first. This arrangement also allows the physician to access the chart and history and then sign off on the suggested codes. In addition to the above, the verification of charge codes by a physician may be done on paper, and faxed or scanned and e-mailed to the coding terminal.

Coding terminal 122 can communicate with other terminals and with the internet across a network 120. The term “coding terminal” is used herein to refer to a terminal through which patient reports and other medical information can be received, charge codes identified, and reports provided to medical professionals, and charge codes transmitted to insurance carriers; the term is used to distinguish such a terminal from other terminals, such as the medical provider terminal 142, through which a physician or other medical professional can create patient reports and transmit them to the coding terminal 122.

The medical provider terminal 142 is similar to other devices discussed herein. For example, the processor 144 is similar to the processor 104 and 124. Medical terminal may include an input interface and a display, such as display 158 that can display a graphical user interface (GUI). Medical provider terminal also includes an interface similar to that of interface 116, and a memory 146 similar to that of memory 106. In addition, medical provider terminal 142 can include a patient medical intake application 154, through which a physician or other medical professional can input medical information about a patient. The patient medical intake application can also include an interface through which a physician can verify charge codes received from a coding terminal, though such an interface can be provided on another local or remote application accessible through the medical provider terminal or through a another device. Memory 146 can include patient medical information, including medical history. Medical history can include current and past medical information, such as x-rays and other images, prescriptions, previous diagnoses and treatments, chronic medical conditions, current and previous medical conditions, previous vitals information, etc.

After charge codes are verified, they can be stored in a repository for other analyses. For example, utilization models can be generated based on charge codes identified. An example utilization model may include identifying Diagnostic Related Groups that are paid for under a flat fee model. The actual costs associated with the DRG can be determined based on certain metrics that can be accumulated and analyzed. The actual costs can be compared against the flat fees collected to determine net gains and losses, efficiency of certain treatments, etc. The metrics and the DRGs can be tracked using charge codes identified from physicians reports and from other medical information for each patient.

Also, analyses on labs, procedures, pharmaceuticals, and/or imaging can be performed. For example, different pharmaceuticals can be prescribed to treat similar ailments. The pharmaceuticals prescribed to certain patients for certain ailments by certain physicians can all be tracked based on charge codes identified from physician reports and other medical information. The data can be stored in a repository. It may be beneficial to identify the differences in treatment regimen for physicians at the same facility or across different facilities. This analysis can be used to compare the costs associated with medical treatments for similar medical conditions, and in some circumstances, reduce them. In addition, results of prescribed treatments can be compared. By making charge coding as comprehensive as possible, the differences and similarities between patients can be kept track of, thereby allowing a meaningful comparison across different patients to be executed. This analysis can reduce the cost of treatment while also increasing its efficacy for patients with similar medical histories. The same or a similar analysis can be performed for labs, procedures, imaging, etc.

It will be understood that there may be any number of terminals communicably coupled to server 102. This disclosure contemplates that many users may use a computer or that one user may use multiple computers to submit or review queries via a graphical user interface (GUI). As used in this disclosure, clients may operate remote devices, such as personal computers, touch screen terminals, workstations, network computers, kiosks, wireless data ports, wireless or wireline phones, personal data assistants (PDAs), one or more processors within these or other devices, or any other suitable processing device, to execute operations associated with business applications. For example, a terminal may be a PDA operable to wirelessly connect with an external or unsecured network. In another example, a terminal may comprise a laptop that includes an input device, such as a keypad, touch screen, mouse, or other device that can accept information, and an output device that conveys information associated with the operation of server 102 or a terminal, including digital data, visual information, or GUI. Both the input device and output device may include fixed or removable storage media such as a magnetic computer disk, CD-ROM, or other suitable media to both receive input from and provide output to users of a terminal through the display, namely, over GUI.

Generally, FIG. 1 provides merely one example of computers that may be used with the disclosure. In other words, the present disclosure contemplates computers other than general purpose computers, as well as computers without conventional operating systems. The term “terminal” is intended to encompass a personal computer, workstation, network computer, mobile computing device, smartphone, tablet, or any other suitable processing device. For example, although FIG. 1 illustrates one server 102 that may be used with the disclosure, system 100 can be implemented using computers other than servers, as well as a server pool. Server 102 may be adapted to execute any operating system including z/OS, Linux-Intel® or Linux/390, UNIX, Windows Server®, or any other suitable operating system. According to one implementation, server 102 may also include or be communicably coupled with a web server and/or an SMTP server.

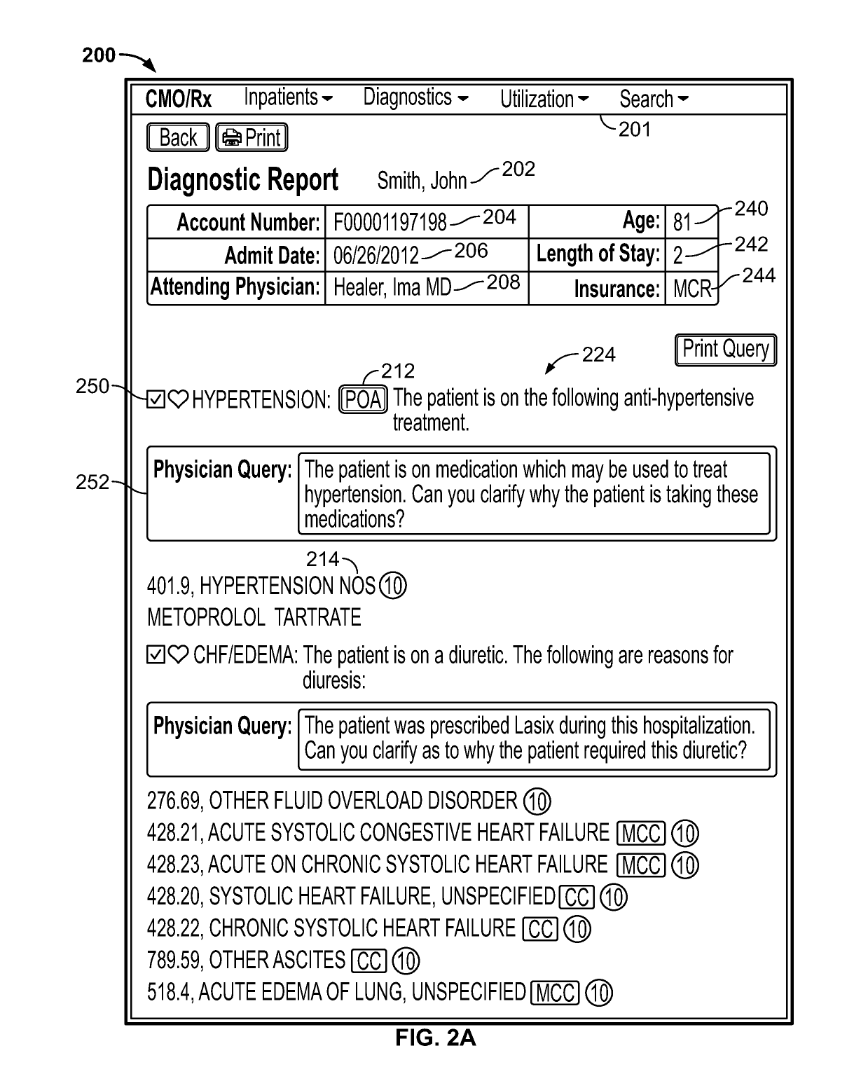

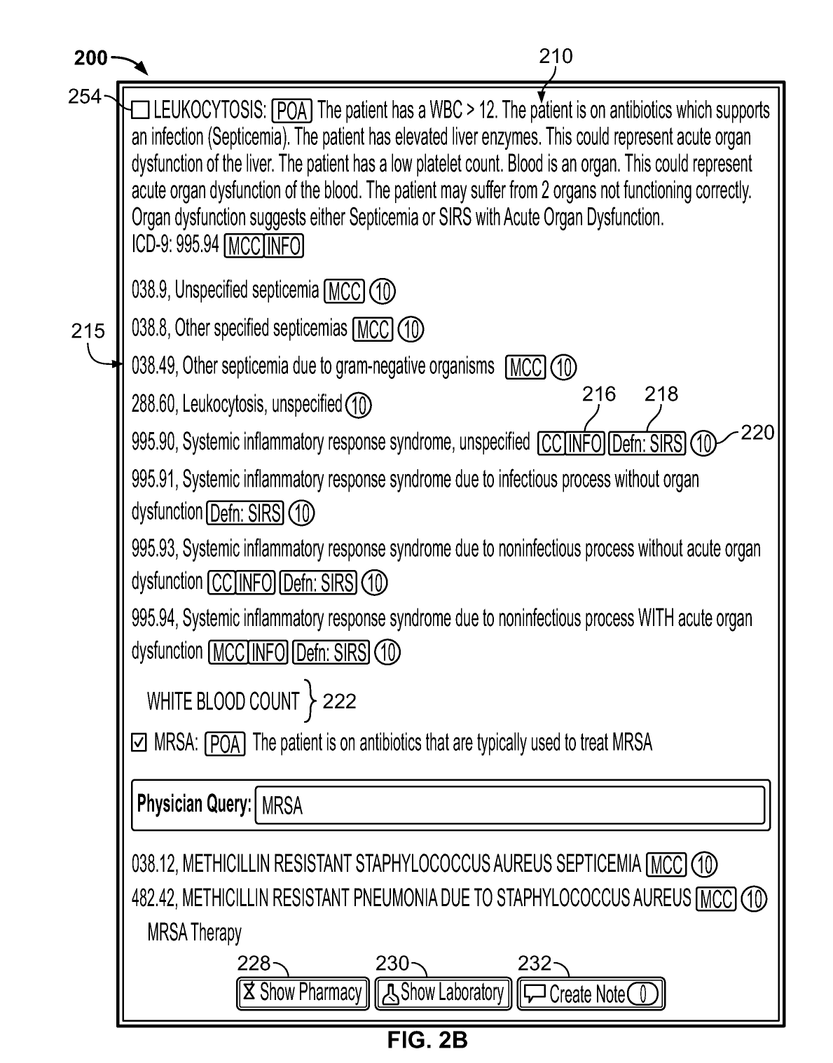

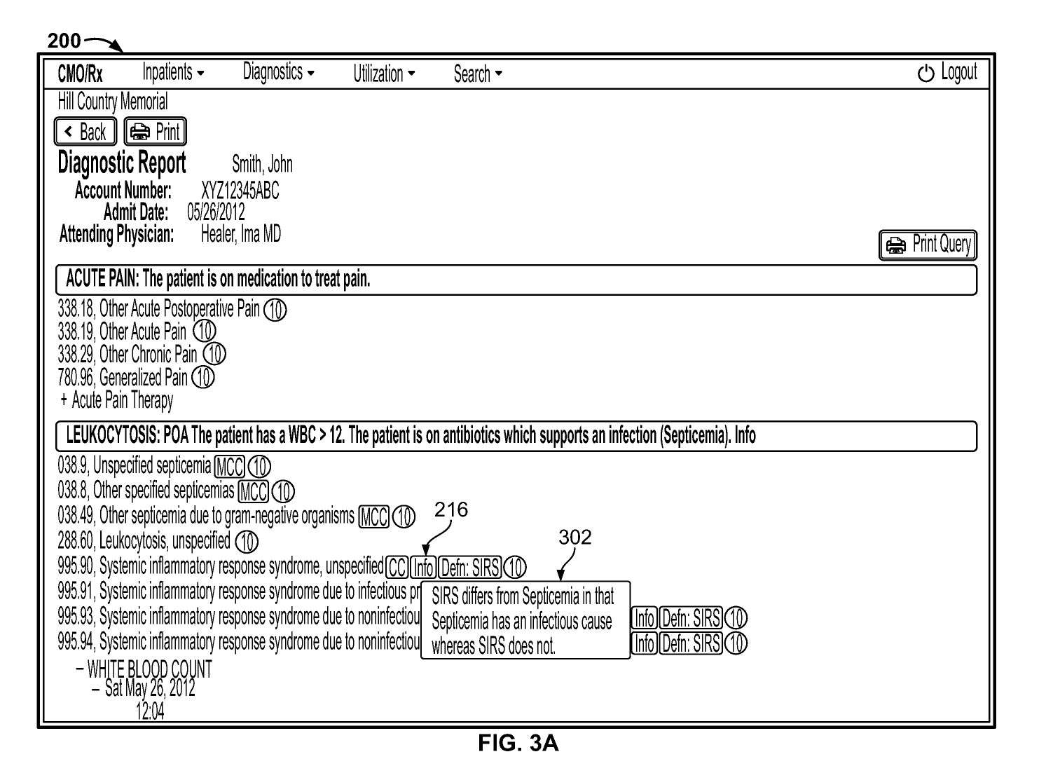

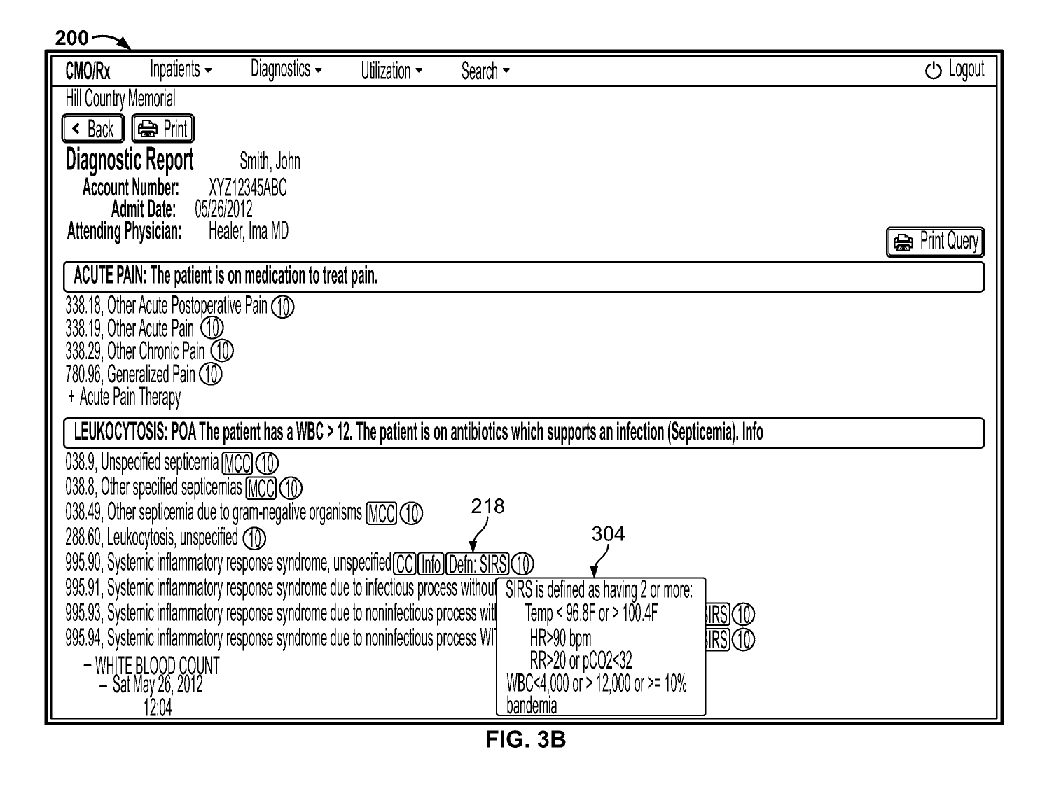

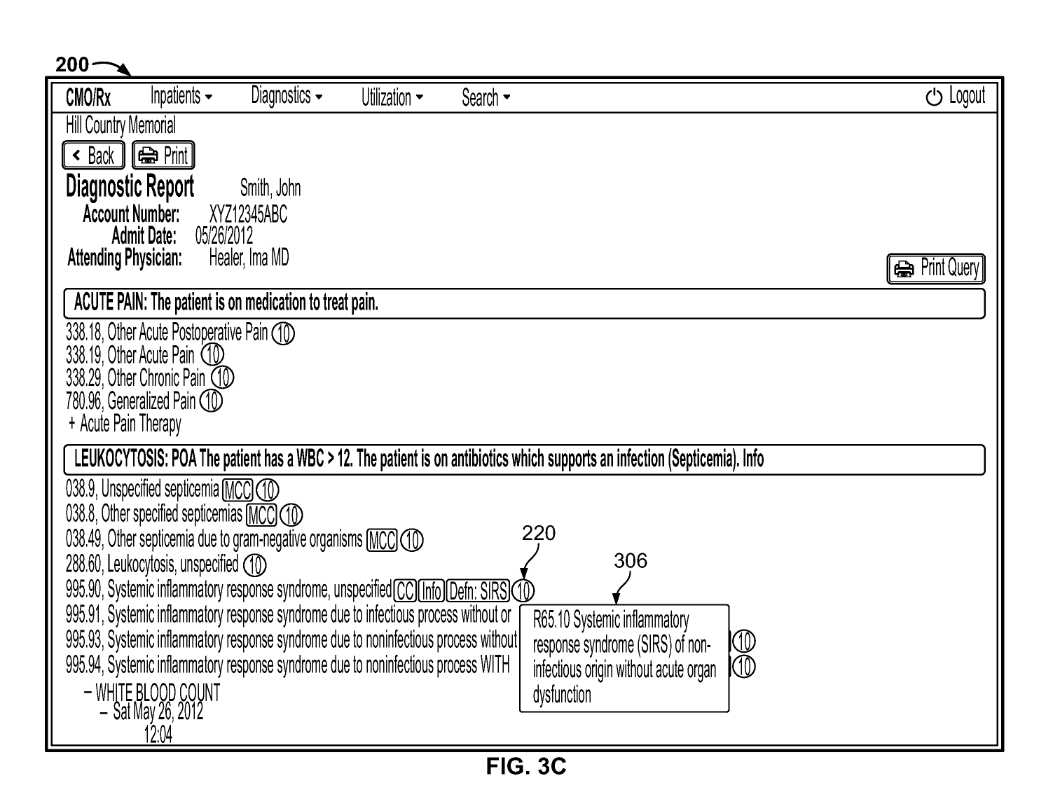

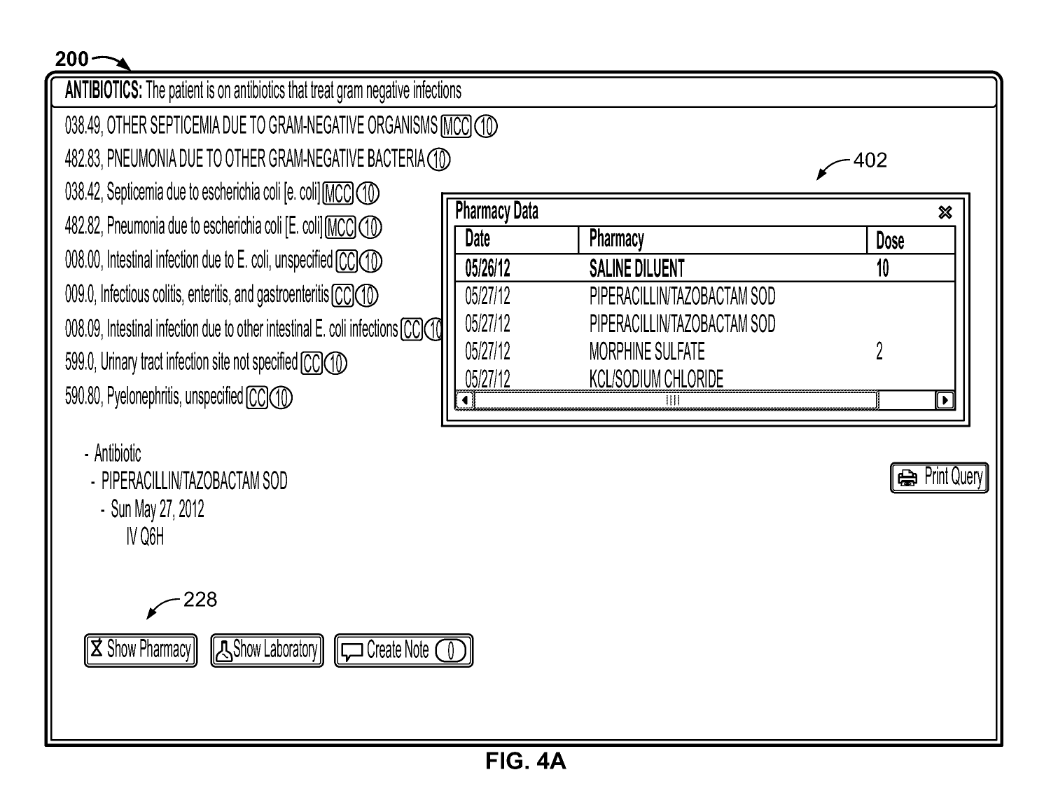

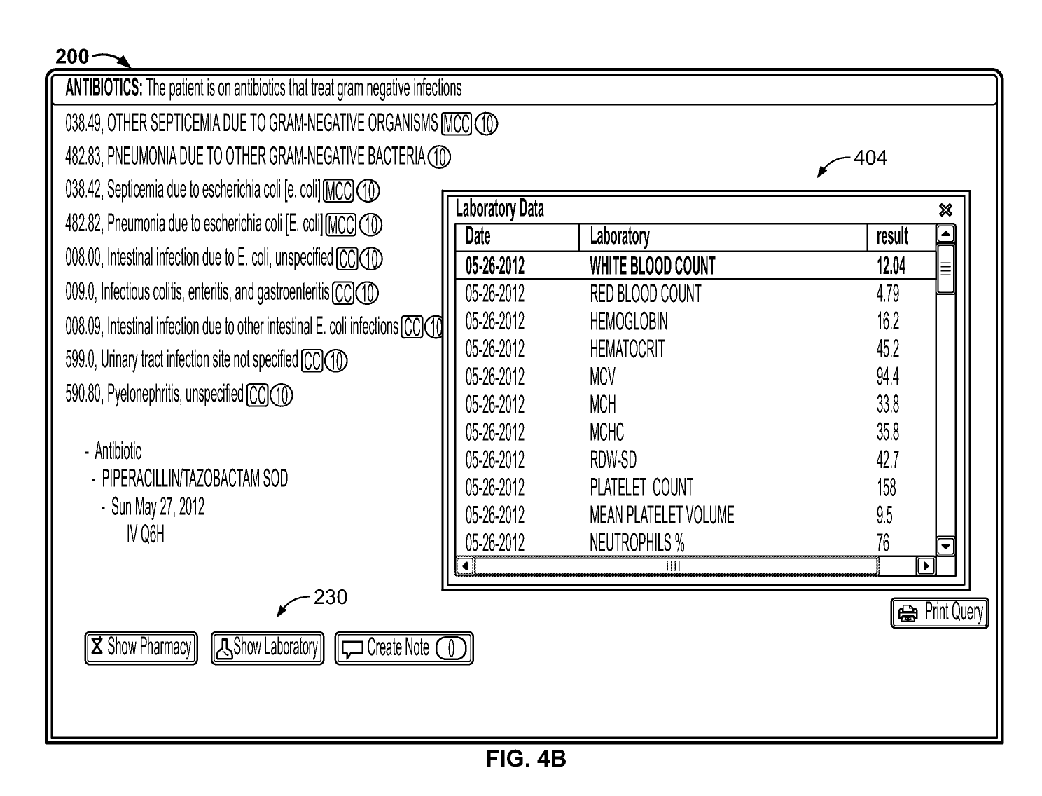

FIGS. 2A-2B are screen shots of an example graphical user interface for showing a diagnostic report for a patient showing the possible charge codes identified by system. FIGS. 2A-2B are meant to convey a single graphical user interface, but is split into two parts for clarity. The GUI 200 shown in FIGS. 2A-2B is similar to the example GUI shown in FIGS. 3(A)-4(B). GUI 200 may be similar to the GUI described above in connection with the host application 134.

GUI 200 includes a set of drop down menus 201 that can be selected by an operator to execute certain functions, view data, input data, run reports, etc. The portion of GUI 200 shown in FIG. 2A shows the set of drop down menus 201. In addition, the patient John Smith 202 and attending physician Ima Healer 208 are shown. The patient's account number 204 and admission date 206 are also shown. Additionally, some other patient information can be shown, including patient's age 240, the length of stay at the medical facility 242, and the insurance carrier/provider 244 (Medicare in this example).

A medical condition that the patient had present on admission is shown as entry 224, which in this example is hypertension. Entry 224 is designated by a field “POA” 212 that indicate the current conditions present upon admission. Below the Entry 210 are other, related conditions, such as hypertension NOS 214, which has a charge code 401.9.

Next to entry 224 is a checkbox 250, which when checked opens a physical query box 252. Physician query box 252 can include one or more statements pertaining to the entry 224, as well as questions directed to the physician (attending, diagnosing, etc.) about the entry. In this case, the question asks whether the physician can clarify why the patient is taking medications to treat hypertension. The questions can be entered manually or may be selected from a set of questions previously asked or defined. The questions are not themselves diagnoses. Rather, the questions are specifically constructed to request clarification from the physician. In certain implementations, entries in physician query box can be transmitted to the physician electronically. For example, the physician may receive an e-mail, instant message, or other type of message with a notification of the message. The notification can include a link that directs the physician to a software interface that includes the physician query message. The physician can interface with the software to answer the query. In some instances, the physician query message can be sent directly to the physician.

On FIG. 2B, the second portion of GUI 200 is shown. Here, entry 210 is Leukocytosis, which applies if the patient has a white blood cell count over 12. The lab 222 shows a white blood count, which can be expanded to show labs and lab results that may have been performed, such as a white blood cell count. Entry 210 also includes a checkbox 254, which in this example, is not checked. Related conditions 215 are listed below entry 210. The related conditions 215 provide conditions and charge codes that relate to the entry 210.

In addition to the related conditions 215, other information is available, such as general information 216, definitions 218, and sub-diagnoses 220. FIG. 3(A) is a screenshot of an example graphical user interface (GUI) 200 showing information pertaining to a medical condition. In this example, the medical condition is systemic inflammatory response syndrome (SIRS), and hovering over the “info” link pops up a box 302 with information pertaining to SIRS. FIG. 3(B) is a screenshot of an example graphical user interface 200 showing a definition pertaining to a medical condition. In this example, the medical condition is systemic inflammatory response syndrome (SIRS), and hovering over the “Defn: SIRS” link pops up a box with a definition pertaining to SIRS. Definitions may be relevant to the identification of charge codes. For example, in some circumstances, a physician's understanding of a condition does not exactly line up with how charge codes are defined. The system can identify charge codes that a physician may not. For example, a physician may not diagnose hyponatremia if a patient's sodium levels were above 130. The charge code for diagnosing the condition would apply, however, at sodium levels lower than 135. The system can identify sodium levels of a patient based on received medical information from a report or medical history, and prompt the physician whether a diagnostic charge code for hyponatremia should be added.

FIG. 3(C) is a screenshot of an example graphical user interface 200 showing further information pertaining to a medical condition. In this example, hovering over the “10” circle pops up a box showing a sub-diagnosis for SIRS.

Lab reports 222 are also shown, as well as other therapies and pharmacy reports. In this case, the lab report shows a white blood cell count. Other information can also be shown. The information can be used to determine whether a certain condition applies

Also shown are user-selectable links. Selecting the Show Pharmacy link 228 pops up a window showing pharmaceuticals for the patient. FIG. 4(A) is a screenshot of an example graphical user interface 200 showing historical pharmacy data for a patient. Clicking on the link 228 pops up a box 402 showing pharmaceuticals taken by or prescribed/administered to the patient. Selecting the Show Laboratory link 230 pops up a window showing laboratory history. FIG. 4(B) is a screenshot of an example graphical user interface 400 showing historical laboratory data for a patient. Clicking on the link 230 pops up a box 404 showing pharmaceuticals taken by or prescribed/administered to the patient. The Create Note link 232 pops up a window for a user to enter information.

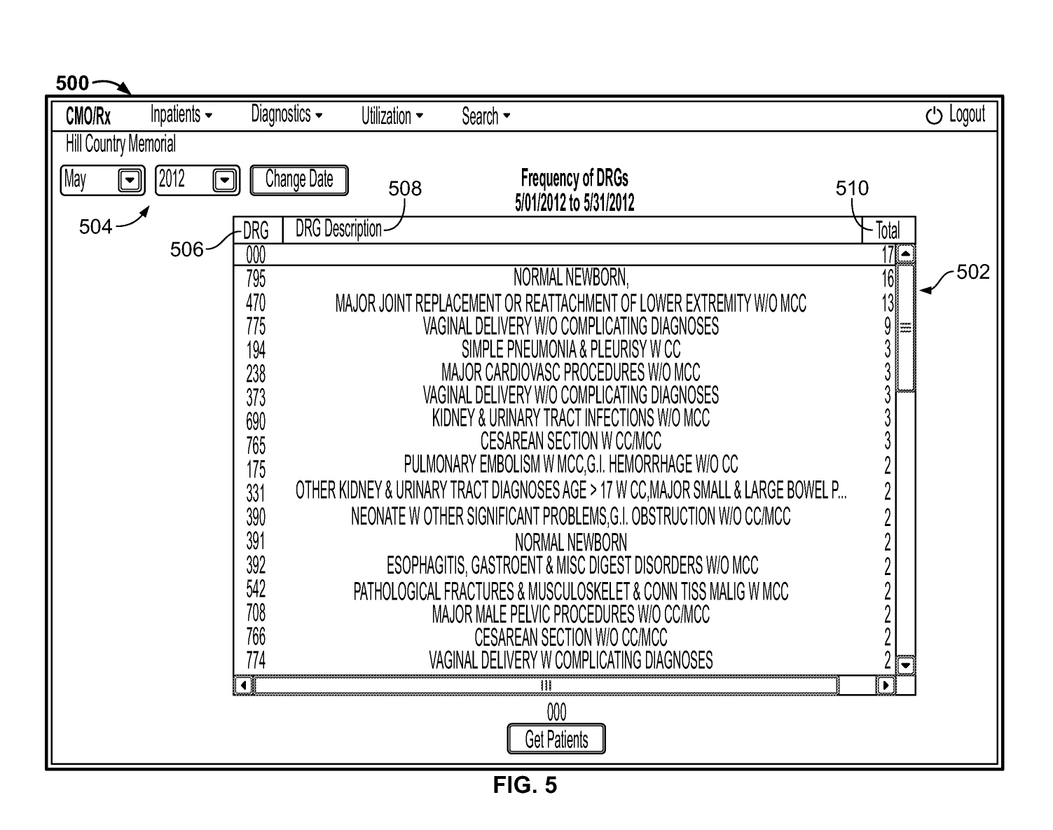

FIG. 5 is a screenshot of an example graphical user interface 500 showing the frequency of certain diagnostic related groups. Reports can be run on diagnostic related groups (DRGs) that may be billed out at fixed fees. The reports can identify actual costs associated with DRGs. GUI 500 shows a table 502 of the frequency of DRGs for a particular time period. The time period can be selected using drop down menus 504. The table 502 lists the DRG by number 506, description 508, and identifies the total number of DRGs 510. A list of DRGs can be displayed that shows the total charges for a DRG. The total charges can be compared against the flat fees that can be billed for the DRG. Costs can be reduced and efficiency increased by monitoring different metrics associated with treatment of DRGs.

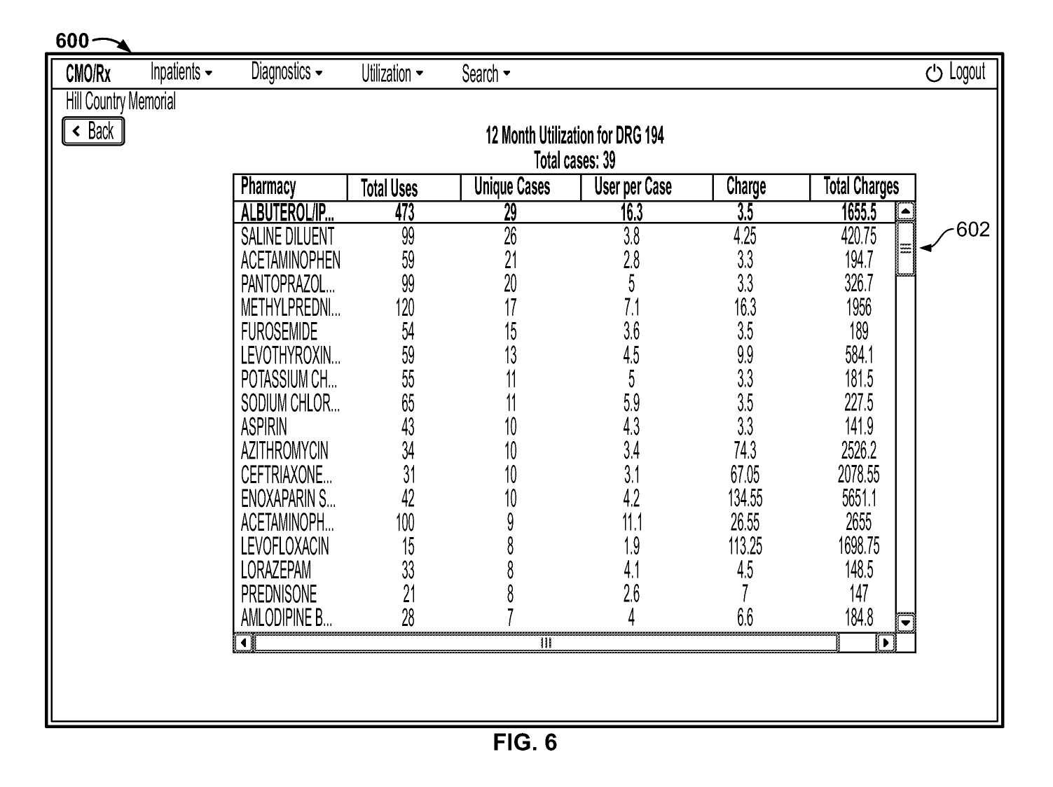

FIG. 6 is a screenshot of an example graphical user interface 600 showing an example twelve month utilization for a certain diagnostic related group (DRG). The DRG in this example is simple pneumonia and pleurisy w CC (DRG #194). GUI 600 shows a table 602 showing the twelve month utilization for DRG #194. There were 39 cases of simple pneumonia. The table 602 shows the pharmaceuticals administered, the total uses, the total charges, and other information. Utilization reports such as these can be used to track and compare treatments, procedures, and pharmaceuticals used by physicians at a certain facility or across different facilities. For DRGs that are paid at a flat fee, the actual costs of diagnosis and treatment can be followed to decrease costs and increase efficiency. For example, charge codes can be used to track metrics and data associated with a DRG. Such data may include the attending physician, the diagnosis, the procedures ordered, pharmaceuticals and dosages ordered, treatments, duration of hospital stays for in-patient care, the costs associated with each of the preceding, and other data. That information can be used to identify potential adjustments to how certain DRGs are handled to reduce the cost and identify physicians who are/are not efficient at handling a DRG.

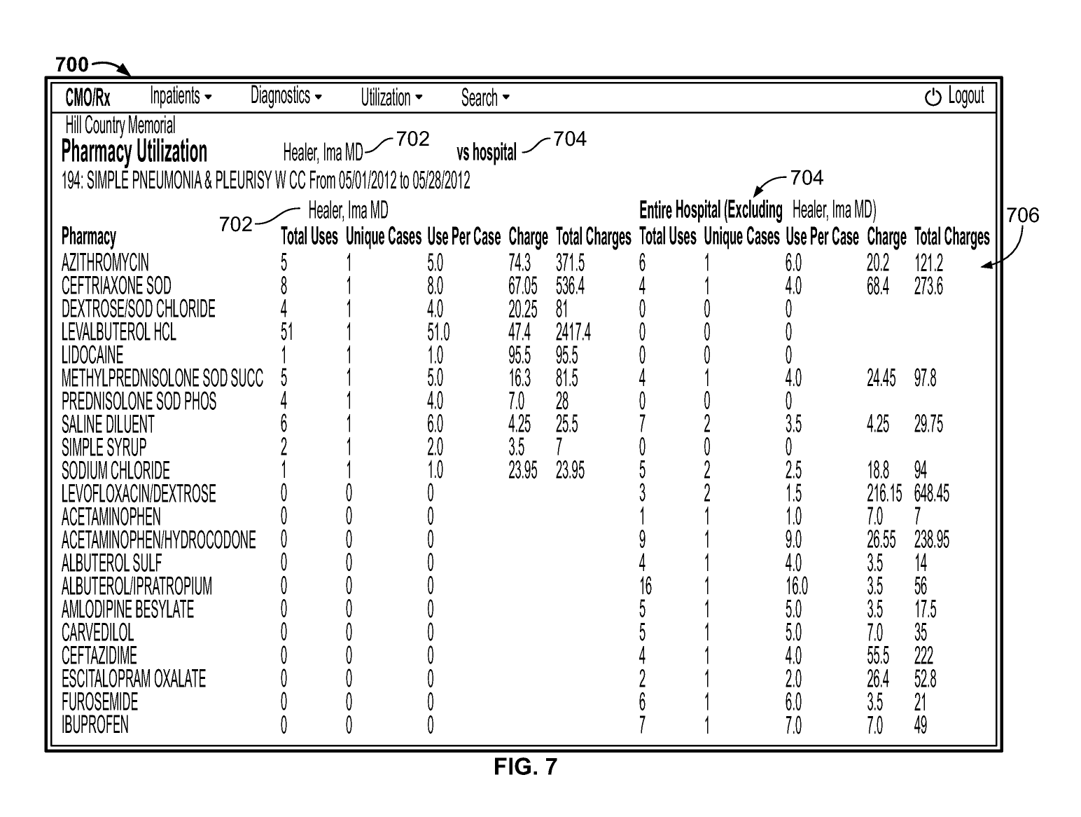

FIG. 7 is a screenshot of an example graphical user interface 700 showing an example pharmacy utilization report for a certain physician compared against other physicians of the same medical facility. GUI 700 shows a pharmacy utilization table 706. The subject 702, here Dr. Ima Healer, is compared against another subject 704, in this case, the remainder of the physicians in this hospital. The table 706 shows the pharmaceuticals prescribed by Dr. Healer over a 28 day period and shows the same information for the remaining physicians at the hospital. Reports such as these can be used to identify what pharmaceuticals are being administered and by whom. Such information can be used to suggest lower cost pharmaceuticals to certain physicians who often use more expensive options. Charge codes can be used to track pharmaceuticals prescribed and related data for certain diagnoses by physicians. Related data may include the total uses, unique cases, use per case, charge, and total charges. The data can be tracked and stored in a repository. The data associated with a first physician (here, Dr. Ima Healer) can be compared against another physician or against all other physicians at the facility or across facilities. The preceding may apply to other aspects besides pharmaceuticals, such as procedures, labs, imaging, and other treatments/diagnostics.

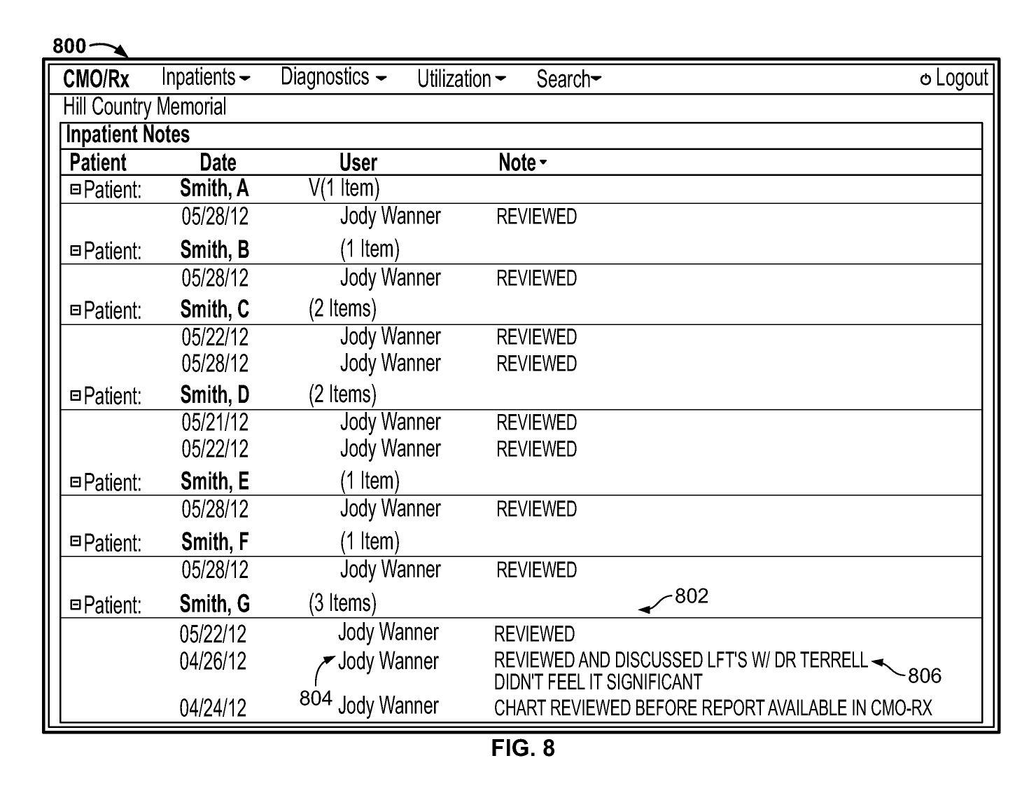

FIG. 8 is a screenshot of an example graphical user interface 800 showing example in-patient notes. Entry 802 shows a patient G. Smith with three sub-entries ranging from Apr. 26, 2012 to May 22, 2012. The case manager 804 is listed who would be responsible for correlating the physicians diagnosis, procedure, etc. with the relevant charge codes. The case manager, operating the coding terminal, would also execute instructions to identify other charge codes based on the order from the physician and from other medical information, such as medical history, pharmacy, x-rays, etc. Here, the case manager is an operator using, e.g., a coding terminal such as that described above. The case manager here has received medical information about G. Smith. In the medical information received, the attending physician did not include a diagnosis or procedure directed at addressing G. Smith's LFTs. The software application running on the coding terminal identified G. Smith's LFT number as a medical condition worth revisiting. The LFT number may have been in the medical information received or it may have been part of a medical history report received along with the medical information. In any case, the physician did not provide an order addressing the LFT to the case manager, and the software identified such a deficiency. The software would then identify a charge code associated with any medical condition, treatment, etc. associated with LFT values that this patient exhibited. The case manager can then return a report to the physician identifying the deficiency or can request a conference with the physician to discuss it. The note 806 here shows that the case manager discussed the LFTs with the physician, who indicated that he or she did not feel it was significant. The charge codes associated with the LFT condition identified by the software, thus, would not be sent to the insurance carrier.

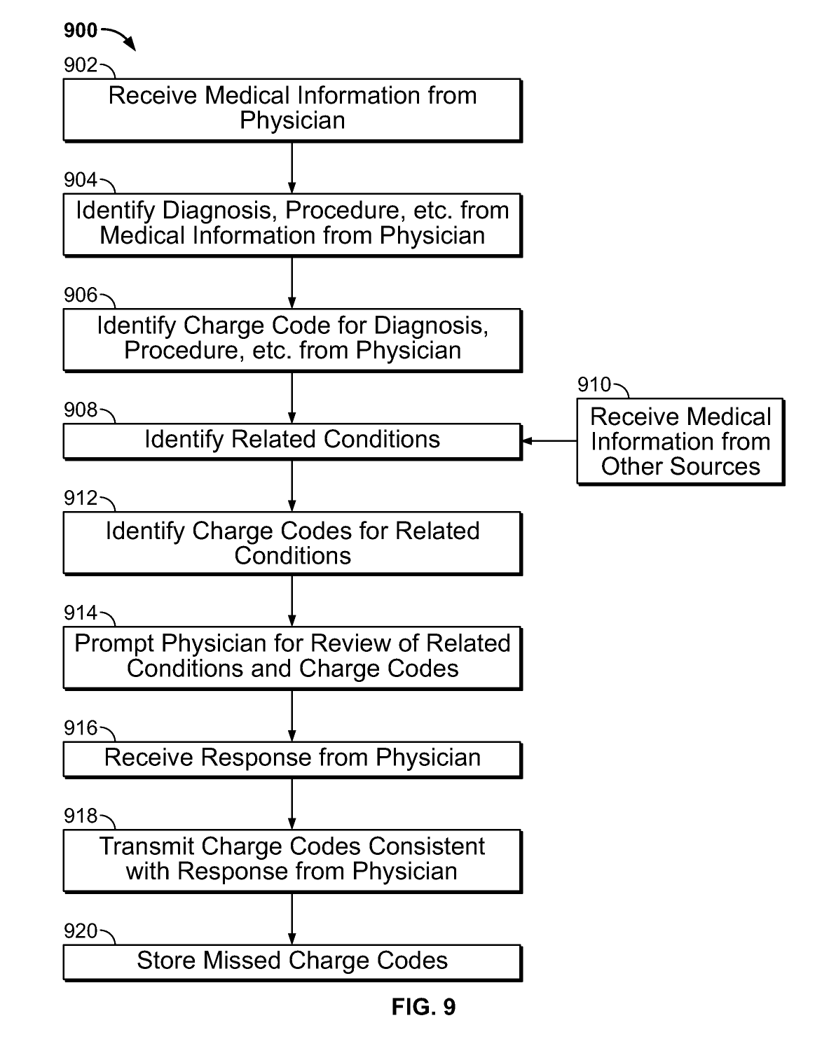

FIG. 9 is a process flow diagram for identifying and verifying charge codes. A physician or other medical professional can meet with a patient who, at the time, is presenting complaints indicating how the patient feels or may physically exhibit a symptom. A physician or other medical professional can add the patient's complaints to a report (often called a chart), together with objective information, such as the patient's vital information, the results of physical examinations, imaging, and any tests or lab results for the patient. The physician can make a diagnosis of a condition based on the complaints and objective information, and possibly also the patient's medical history, and may recommend a procedure, such as a lab, a medical procedure, a prescription, plan for treatment, etc. The physician can put this medical information into the report, which can be electronic or can be scanned into electronic form. The medical information can then be sent to another health care professional, such as a billing professional or case manager who handles billing. The case manager may be operating a coding terminal or other computer station that executes instructions and provides a user interface to access a program that can be used for identifying charge codes. The software program can receive electronic information, parse it either automatically or with the aide of the case manager. In this case, a report containing the medical information is received from the physician or other medical professional (902). The medical information is parsed to identify the diagnosis, procedure, etc. provided in the report by the physician (904) A charge code can be identified for the diagnosis, procedure, etc. (906). In addition, related medical conditions, procedures, labs, or issues can be identified based on at least one of the diagnosis, procedure, symptom, etc. identified on the report; the charge code associated therewith; and/or other medical information (908). For example, prior to analyzing the physician's report, other medical information about the patient can be received (910). This other medical information can include a full medical history, x-rays and other images, pharmaceutical history, surgical history, hospitalization records, other diagnoses, allergies, other information not present in the physician's report, etc. In addition, certain information present in the physicians report, but not explicitly considered in the report can also be noted. For example, as discussed above for G. Smith's LFT. The physician had the patient's LFTs, but did not address them in the initial report. The case manager identified the LFT as having a value associated with a medical condition and a corresponding charge code.

Charge codes for the related conditions can also be identified (912). The application can receive the physician's report (or chart) that includes, e.g., a diagnosis, treatment plan, procedure, etc., and other medical information, such as patient's medical history, objective information, EMR data, etc. An algorithm may be applied to the totality of the medical information received. The algorithm may apply a rule set may include identification and/or filtering criteria specified by organizations that promulgate the charge codes (such as the WHO or the AMA). The algorithm may also use relationships between codes so that related codes are also suggested.

The software can create a prompt for the physician to verify whether the related conditions and corresponding charge codes should be included in the report (914), and send the prompt to the physician. In some circumstances, the prompting may occur while the patient is still with the physician or in the medical facility. A response can be received by the physician, either verifying the new codes or denying them (916). A report with the charge codes (either with some or all of the related charge codes or without them) is then sent to the third party payor for processing and payment (918). The application can compile all the documentation required by the third party payor to support the charge codes and can transmit that documentation or make it available to the biller or third party payor.

Third party payor is a term that is meant to include different types of carriers, including private insurance, semi-private insurance, and public carriers, such as Medicare and Medicaid. The charge codes for the related conditions can be stored in a repository (920), and may be accessed later to run utilization reports and/or other types of analyses.

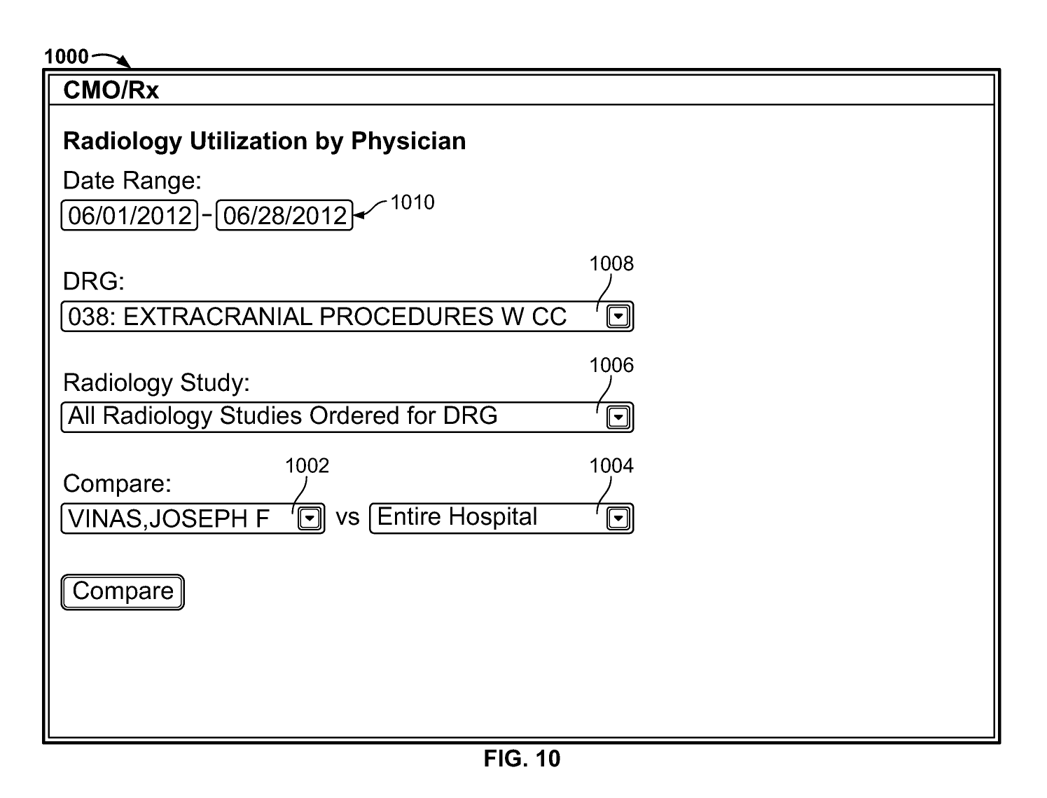

FIG. 10 is an screenshot of an example graphical user interface 1000 for a radiology utilization by physician interface. The utilization can show an analysis of all radiology studies ordered for a selected DRG by a particular physician as compared against another physician or the entire hospital. The subject 1002, here Dr. Ima Healer, is compared against another subject 1004, in this case, the remainder of the physicians in this hospital. Reports can be run for dates selected in the date field 1010. The specific DRG can be selected in a drop down menu 1008. The radiology study can be selected in drop down menu 1006. In this example, the DRG selected is 038: Extracranial procedures W CC, and the radiology study is All Radiology Studies Ordered for DRG. Reports can be used to identify what radiology studies are being administered and by whom. Charge codes can be used to track radiology studies prescribed and related data for certain diagnoses by physicians. The data can be tracked and stored in a repository. The data associated with a first physician (here, Dr. Ima Healer) can be compared against another physician or against all other physicians at the facility or across facilities.

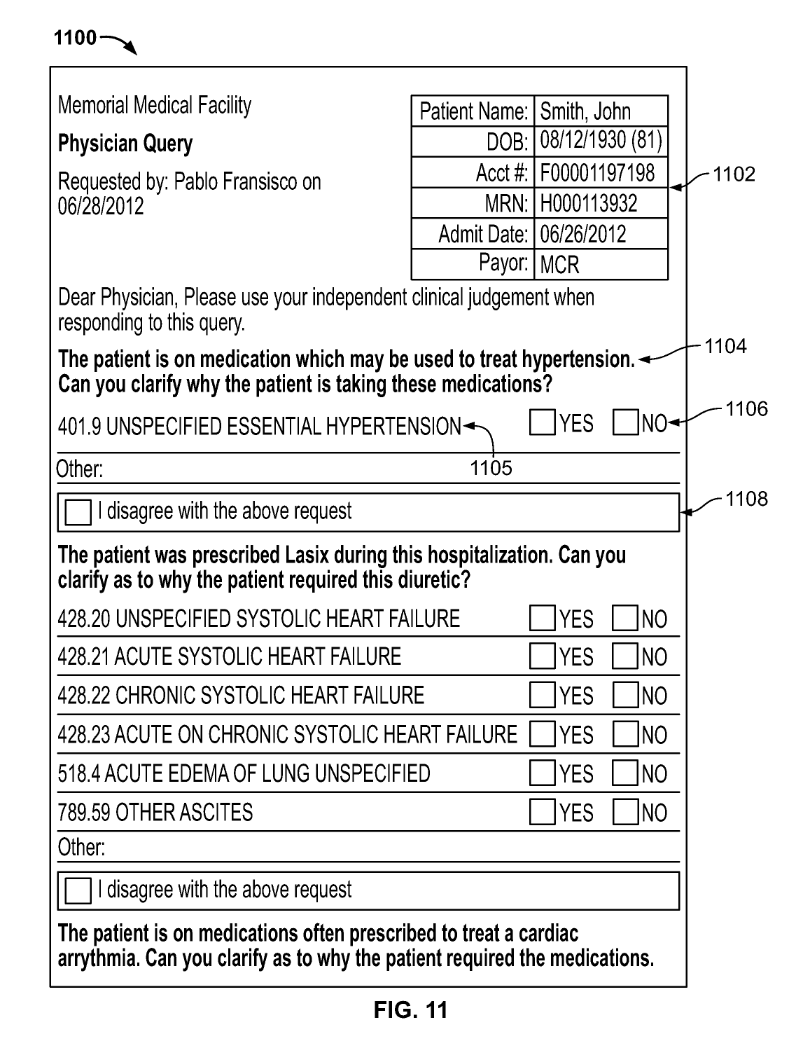

FIG. 11 is a screenshot of an example physician query form 1100. The physician query form 1100 can be generated from the diagnostic reports, such as that shown in FIG. 2A-B. The physician query form 1100 can be an electronic form transmitted to the physician or can be printed and delivered physically. The physician query form 1100 can include patient information 1102, which can include the patient's name, age, date-of-birth, account number, insurance, etc. The checked boxes from diagnostic report 200 can be used to populated the physician query form 1100. For example, query 1104 is similar to the query in diagnostic report 200, which concerns hypertension medication and asks that the physician clarify why the patient is taking hypertension medication. This query serves as a flag for the physician to investigate the query further. Additionally, the form includes a related condition 1105 (here, unspecified essential hypertension) and its associated charge code 401.9. The physician can check a box 1106 (either yes or no) depending on whether the physician believes the related condition charge code should be included among the charge codes sent to the insurance company. The physician may also check a box 1108 if he disagrees with the query in general.

As mentioned briefly above, the physician query form 1100 may be transmitted to the physician electronically or in a physical form. The physician query form may also be displayed as part of a software interface. The physician can interact with the physician query form 1100 using a device, such as a computer or tablet or smartphone. In some implementations, the physician can receive a message indicating that a new physician query form is available for his/her attention. The message can be transmitted via e-mail, instant message, text message, or other messaging service. The message can include the form itself or can include a link to the form. The link can direct the physician to a software interface through which the physician can interact. The software can be a web-based software program accessible through a stand-alone, remotely hosted software application or using a web browser. The software may also be a locally hosted program that imports forms and other data from a network server or other repository.

While this disclosure contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Other implementations fall within the scope of the following claims.

What is claimed is:

1. A computer implemented method comprising:
receiving, electronically, medical information about a patient of a medical provider from an electronic medical record;
automatically identifying, using the received medical information, a charge code associated with a medical condition of the patient from a specified set of a plurality of charge codes upon which a third party will base payment to the medical provider; and
outputting the charge code.

2. The computer implemented method of claim 1, wherein receiving the medical information comprises receiving a diagnosis of the medical condition and the examination information, test information, lab information, imaging information, and pharmaceutical information associated with the diagnosis.

3. The computer implemented method of claim 2, wherein the diagnosis and any associated examination information, test information, lab information and pharmaceutical information is from a specified timeframe, and
wherein receiving the medical information further comprises receiving at least one of a historical diagnosis of another medical condition, historical examination information, historical test information, historical lab information, historical imaging information, or historical pharmaceutical information from a timeframe before the specified timeframe.

4. The computer implemented method of claim 2, wherein the charge code is a first charge code corresponding to the medical condition, and the method further comprises automatically identifying a second charge code corresponding to a second medical condition for which no diagnosis is identified in the medical information.

5. The computer implemented method of claim 4, wherein automatically identifying the second charge code comprises automatically identifying the second charge code using the first charge code.

6. The computer implemented method of claim 1, wherein outputting the charge code comprises outputting the charge code to a physician and prompting a confirmation from the physician that the charge code is correct.

7. The computer implemented method of claim 1, further comprising identifying a second charge code associated with the procedure and providing the second charge code to the physician.

8. The computer implemented method of claim 1, further comprising transmitting the charge code to the third party payor.

9. A system comprising:
a hardware processor operable to execute instructions comprising:
receiving medical information about a patient of a medical provider from an electronic medical record;
automatically identifying, using the received medical information, a charge code associated with a medical condition of the patient from a specified set of a plurality of charge codes upon which a third party will base payment to the medical provider; and
outputting the charge code.

10. The system of claim 9, wherein receiving the medical information comprises receiving a diagnosis of the medical condition and the examination information, test information, lab information, imaging information, and pharmaceutical information associated with the diagnosis.

11. The system of claim 10, wherein the diagnosis and any associated examination information, test information, lab information and pharmaceutical information is from a specified timeframe, and
wherein receiving the medical information further comprises receiving at least one of a historical diagnosis of another medical condition, historical examination information, historical test information, historical lab information, historical imaging information, or historical pharmaceutical information from a timeframe before the specified timeframe.

12. The system of claim 10, wherein the charge code is a first charge code corresponding to the medical condition, and the method further comprises automatically identifying a second charge code corresponding to a second medical condition for which no diagnosis is identified in the medical information.

13. The system of claim 12, wherein automatically identifying the second charge code comprises automatically identifying the second charge code using the first charge code.

14. The system of claim 9, wherein outputting the charge code comprises outputting the charge code to a physician and prompting a confirmation from the physician that the charge code is correct.

15. The system of claim 9, the instructions further comprising identifying a second charge code associated with the procedure and providing the second charge code to the physician.

16. The system of claim 9, the instructions further comprising transmitting the charge code to the third party payor.

17. A computer program product tangibly stored on a non-transient computer readable media, the computer program product operable when executed to perform steps comprising:
receive medical information about a patient of a medical provider from an electronic medical record;
automatically identify, using the received medical information, a charge code associated with a medical condition of the patient from a specified set of a plurality of charge codes upon which a third party will base payment to the medical provider; and
output the charge code.

18. The computer program product of claim 17, wherein receiving the medical information comprises receiving a diagnosis of the medical condition and the examination information, test information, lab information, imaging information, and pharmaceutical information associated with the diagnosis.

19. The computer program product of claim 18, wherein the diagnosis and any associated examination information, test information, lab information and pharmaceutical information is from a specified timeframe, and
wherein receiving the medical information further comprises receiving at least one of a historical diagnosis of another medical condition, historical examination information, historical test information, historical lab information, historical imaging information, or historical pharmaceutical information from a timeframe before the specified timeframe.

20. The computer program product of claim 18, wherein the charge code is a first charge code corresponding to the medical condition, and the method further comprises automatically identifying a second charge code corresponding to a second medical condition for which no diagnosis is identified in the medical information.

21. The computer program product of claim 20, wherein automatically identifying the second charge code comprises automatically identifying the second charge code using the first charge code.

22. The computer program product of claim 17, wherein outputting the charge code comprises outputting the charge code to a physician and prompting a confirmation from the physician that the charge code is correct.

23. The computer program product of claim 17, further operable when executed to identify a second charge code associated with the procedure and providing the second charge code to the physician.

24. The computer program product of claim 17, further operable when executed to transmit the charge code to the third party payor.
